(19) United States
(12) Patent Application Publication
(10) Pub. No.: US 2011/0249290 A1
(43) Pub. Date: Oct. 13, 2011

(54) METHOD AND PROGRAM FOR SMART RECOVERY FROM PRINT FAILURE

(75) Inventors: Kenneth David HAYBER, Fountain Valley, CA (US); Isao HAYAMI, Kanagawa (JP)

(73) Assignee: KONICA MINOLTA SYSTEMS LABORATORY, INC., Huntington Beach, CA (US)

(21) Appl. No.: 12/756,209

(22) Filed: Apr. 8, 2010

(51) Int. Cl. G06F 15/00

(52) U.S. Cl. 358/1.15

(57) ABSTRACT

A method and a printer for recovering a printing job by a user from a printer's control panel after the printer is stopped either automatically by the printer due to a printer error, or manually by a user either because the user notices a printer error or simply wants to modify the settings of an on-going printing job. Embodiments of the method and printer provide on the printer's control panel user interfaces to allow the user, while the printing job is paused, to select an option that changes the printer into a repair mode, modify job settings of the printing job, and select job restart specifications, so that the stopped printing job can be recovered based on the modified job settings and the selected job restart specifications. Particularly a non-fixable printer problem may be avoided when the printing job is resumed by disabling or not using a non-fixable printer part.

### BACKGROUND OF THE INVENTION

1. Field of the Invention

This invention relates generally to methods and programs for managing print jobs, and in particular, it relates to methods and programs for recovery from print failures.

2. Description of Related Art

Almost everyone who have used a printer before have encountered some type of printer “failures”, from minor problems that can be quickly fixed to more serious mechanical problems that often result in certain functions of the printer cannot be performed.

Often times when the problem is minor, it may be fixed by a user and the printing job can resume. For example, when there is a paper jam or misfeed, the printer will automatically stop processing the print job, and the user needs to go to the printer, locate the jammed or misfed paper, and clear the jams or remove the misfeeds. After the problem is corrected, the user needs to restart the printer and the printing job may resume.

Sometimes the problems may not be sensed or detected by the printer and therefore do not result in automatic stopping of the printer, but when noticed by a user, the printing job is often manually stopped. For example, when the print-out pages are wrinkled or marred by dirty rollers, the printer may not detect the problem and stop printing, but the user may have noticed the problem in the middle of the printing process and stops the printing by pressing a button on the printer (e.g. the “Cancel” button). After the problem is corrected, the user often needs to resubmit the job.

In some other situations a mechanical failure in one part of the printer may prevent the printer from performing a function associated with the failed part, but the printer may continue performing other functions unrelated to that part. This may be illustrated by a typical printer described in, e.g., U.S. Pat. No. 7,175,173 B2 issued to Anzai et al. on Feb. 13, 2007.

As shown in cross-sectional view in FIG. 1, a typical printer 10 has one or more attached finishing units (two finishing units 12 and 14 are shown here). An image read apparatus 16 is mounted on the top of printer 10. Papers (P) are stored in one or more paper trays (two paper trays 18 and 20 are shown here). An image is formed on a sheet of paper in an image forming section 22 with a photoconductor 24 through an electrophotographic process, and the formed image is fixed on the sheet of paper by a fixing apparatus 26. A sheet of paper with an image formed thereon is ejected out to finishing unit 12 by an ejection roller 28.

In printer 10, the paper conveyance paths include a paper conveyance path 30 from paper trays 18 and 20 to image forming section 22, a paper conveyance path 32 from image forming section through fixing apparatus 26 to ejection roller 28, and a back conveyance path 34 for reversing and conveyance.

The image forming modes include a single side face down mode, a single side face up mode and a double-side mode. In the single side face down mode, a sheet of paper with an image formed on one side is reversed by the processing of reversing, and then conveyed and ejected by the ejection roller 28. In the single side face up mode, a sheet of paper with an image formed on one side is directly conveyed to the sheet conveyance path 32 and ejected by the ejection roller 28. In the double-side mode, a sheet of paper with an image formed on one side, having passed the fixing apparatus 26 is conveyed downward to go through the back conveyance path 34, and after having been reversed is conveyed to the sheet conveyance path 30 again, so that a back face image is formed on the other side of the sheet of paper by the image forming section 24 before the sheet of paper passes through the fixing apparatus 26 again and is conveyed and ejected by the ejection roller 28.

Finishing unit 12 is a finisher for some of the finishing functions such as punching, stapling, stacking and/or shifting of the printed sheets of paper. In the illustrated example, it contains a punching processing section 36 and one or more folding sections (three folding sections 38, 40 and 42 are shown here) along the paper path 44.

Finishing unit 14 is a finisher for some additional finishing functions such as stacking and stapling. In the illustrated example, it has a stacker 46 and stapling section 48 to apply stacking and/or stapling to the sheets of paper before ejecting them into an elevating ejection tray 50.

From the above illustration of the printer components and functions, it can be seen that if a mechanical problem cannot be fixed but the setting which caused the problem can be avoided, the user may then choose to cancel the job at the printer. The user may then resubmit the job and modify the settings via a printer driver software program installed on a computer connected to the printer either locally or through a network, to avoid the offending settings and their associated problems. For example, if the user knows that the two-sided printing path is malfunction, then the user may resubmit the job and disable two-sided printing feature via a computer-based printer driver program. Or if the user knows that the stapler is broken, then the user may resubmit the job without requesting stapling at the finish of the job via the printer driver program.

In these instances described above, the interruption to the printing process often causes trouble to the user. For example, the copy count for the printing job may be off and will need to be readjusted. If the job was one copy, some pages may need to be reprinted. If the job was multiple copies, the set interrupted by the error may need to be reprinted. The user must account for the good pages and readjust the copy count accordingly when resubmitting the job.

It would be preferable to have a printer-based option that allows the user to stop an in-progress job, modify the settings to avoid known problems, specify the restart point (e.g., page, set or job), then release and process the job. This printer-based option would be particularly useful for “on-the-fly” recovery of large print jobs in print shop environments.

### SUMMARY

The present invention is directed to a method and program for smart recovery from print failures.

It is an object of the present invention to provide a method and program for “on-the-fly” print job recovery that is printer-based without the need of going back to the user's computer to modify the print job settings through a printer driver from the user's computer.

Embodiments of the present invention provide a method and program that allows a user to manually pause a job whenever the user prefers—with or without an error condition occurring—and modify the print job setting at the printer.

Embodiments of the present invention also provide a method and program for printer-based job setting modification that allows a user avoid problematic printer parts or functions and proceed with the printing job with working printer parts or normal functions.

Embodiments of the present invention additionally provide a method and program that provides printer-based job setting modification on restart specification to resolve copy/count problems after an interruption caused by a printer error or failure.

Embodiments of the present invention further provide a method and program for managing and controlling resumption of a printer job to help reduce waste of resources by allowing a user to correct and reprocess the same print job rather than splitting it into multiple separate jobs where the user must manually track and recover from waste.

Embodiments of the present invention also provide a method and program to increase the efficiency and reduce mistake by keeping the entire process contained in a single print job.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, embodiments of the present invention provide a method and program for method for recovering a printing job by a user from a printer's control panel after the printer is stopped and while the printing job is paused. The method includes the step of providing a graphical user interface (GUI) on the printer's control panel to allow the user to select an option that changes the printer into a repair mode after the printer is stopped either automatically by the printer due to a printer error, or manually by a user either because the user notices a printer error or simply wants to modify the settings of an on-going printing job. Next, the method continues with a step of providing a GUI on the printer's control panel to allow the user to modify job settings of the printing job, which is verified to make sure that the modified job settings are acceptable by the printer. The method also includes the step of providing a GUI on the printer's control panel to allow the user to select job restart specifications. Finally, the method includes a step of restarting the printing job based on the modified job settings made by the user and the job restart specifications selected by the user.

In another aspect, embodiments of the present invention provide a printer having a control unit which includes a memory for storing computer readable program code, a control panel coupled to the control unit for providing a user interface, a print engine controlled by the control unit, and a processor for executing the code to control the printer, the computer readable program code being configured to cause the printer to execute a process for recovering a printing job by the user from the control panel after the printer is stopped and while the printing job is paused, wherein the process includes the steps of providing job setting options on the printer's control panel to allow a user to modify job settings of the printing job from the printer's control panel, receiving a first user input on job setting modification, providing job restart specifications on the printer's control panel to allow the user to select job restart specifications from the printer's control panel, receiving a second user input on job restart specification, and restarting the printing job based on the job setting modification and job restart specification input by the user.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a cross-sectional view of a typical conventional printer.

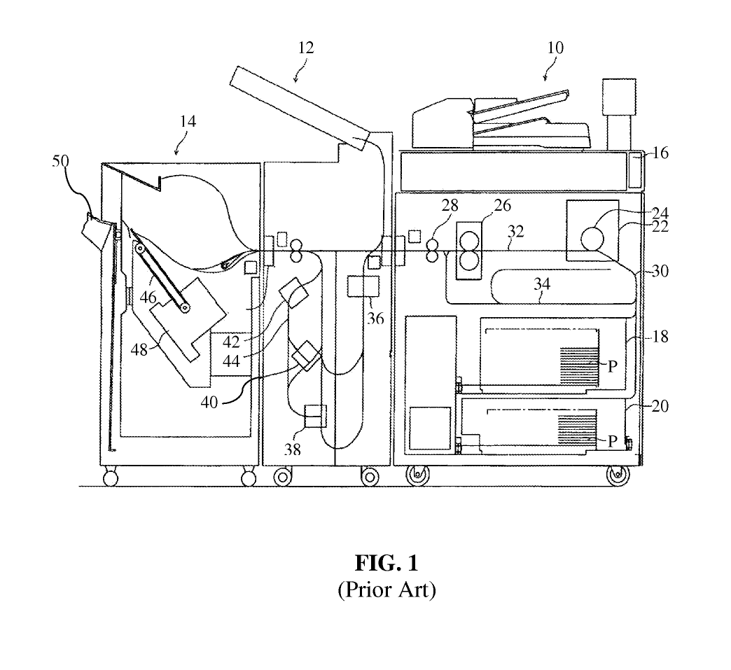

FIG. 2 illustrates a set up or arrangement of a printing system according to an embodiment of the present invention.

FIG. 3 illustrates a process implemented by a printer-based “on-the-fly” print job error recovery method and program according to an embodiment of the present invention.

FIG. 4 shows an exemplary GUI of the printer control panel display for a “Repair” mode option according to an embodiment of the present invention.

FIG. 5 shows an exemplary GUI of the printer control panel display for modifying job settings according to an embodiment of the present invention.

FIG. 6 shows an exemplary GUI of the printer control panel display for selecting restart options according to an embodiment of the present invention.

### DETAILED DESCRIPTION OF PREFERRED EMBODIMENTS

Embodiments of the present invention provide a method for smart recovery from print failures. The present invention method may be implemented by a printer-based computer software program that has program codes and instructions for implementing the steps of the present invention.

The term “printer” used herein may be small desk-top printers typically seen in an office environment, or large printing systems used in print/copy departments at large organizations or professional print shops. It may also cover other similar image and document processing devices such as copiers or multifunction (“all-in-one”) printers that also have copier, scanner and/or facsimile functions. The printer may be directly attached to a computer or server locally, or connected to a computer or server through a network remotely, where the computer or server are used to generate and send a print job to be processed by the printer through a printer driver which is a computer software program normally installed on the computer or server for converting the document or image to be printed to the form specific to the printer.

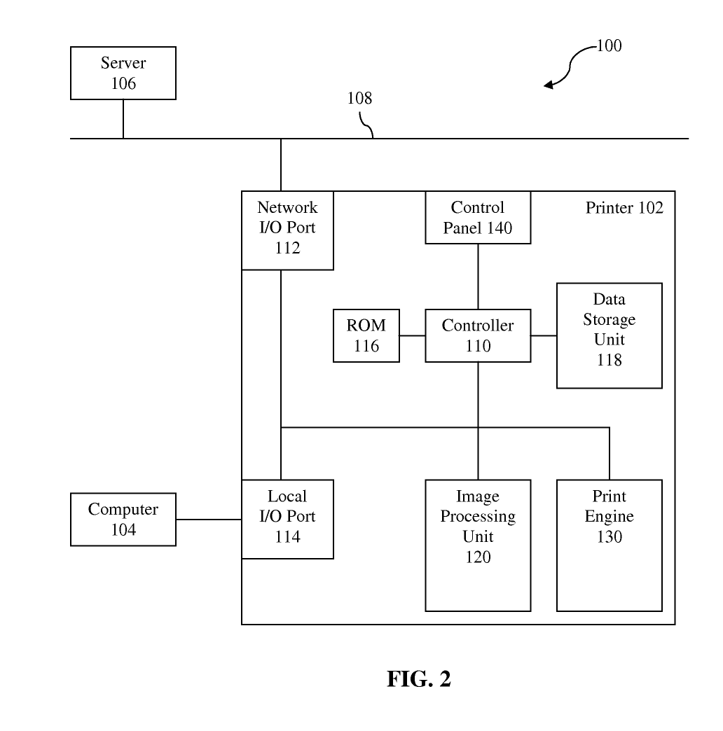

FIG. 2 is a schematic block diagram showing an exemplary printing system set up arrangement 100 in which embodiments of the present invention may be implemented. In the printing system set up or arrangement 100, a printer 102 may be directly attached to a local computer 104, or remotely connected to a server 106 through a data communication channel 108 which may be a wired or wireless network, a serial bus or a dedicated cable connected to the printer 102.

The term “printer-based” used herein means that the software program exemplary implementing the present invention method and process is installed on and executed from the printer 102. As shown in FIG. 2, printer 102 includes a controller or control unit 110, an image processing unit 120 and a print engine 130. Printer 102 also has a local input/output (I/O) port 112 for connection with local computer 104, and a network I/O port 114 for connection with remote server 106. The control unit 110 controls the other internal units of printer 102 and is connected to a control panel 140, a read-only memory (ROM) 116 and a data storage unit 118. The software program exemplary implementing the present invention method and process is installed on ROM 116 or data storage unit 118 and can be accessed and executed by the control unit 110. The control panel 140 is accessible by a user. The control panel 140 includes a display screen such as a liquid crystal display (LCD) display screen and user input means such as keys, buttons, touch screen, etc. for a user to communicate with and control the function and operation of printer 102.

One of the common problems addressed in the present invention arise from the following exemplary situation. A user is processing a print job. The job experiences a technical problem (e.g., a paper jam). In normal situations, the user goes to the printer, clears the jam, and the printer re-initiates and the job continues. In many cases, the exact same jam occurs a second time. This is often caused when the printer requires service. The mechanical problem that generates the problem will reoccur until the printer is serviced and the problem is repaired. Such problems do not prevent the printer from processing all jobs. The user may cancel the job and then resubmit it, using the driver to modify the job settings and deselect the setting that caused the malfunction. However, with the present invention method and program, the user needs not to go back to the computer or server to modify the job through the printer driver, but rather can do that at the printer.

Therefore, one embodiment of the present invention presents a method and program for a solution of the problems described above, providing an expanded functionality that allows the user to switch a printing job to a “Repair” mode for printer-based “on-the-fly” modification.

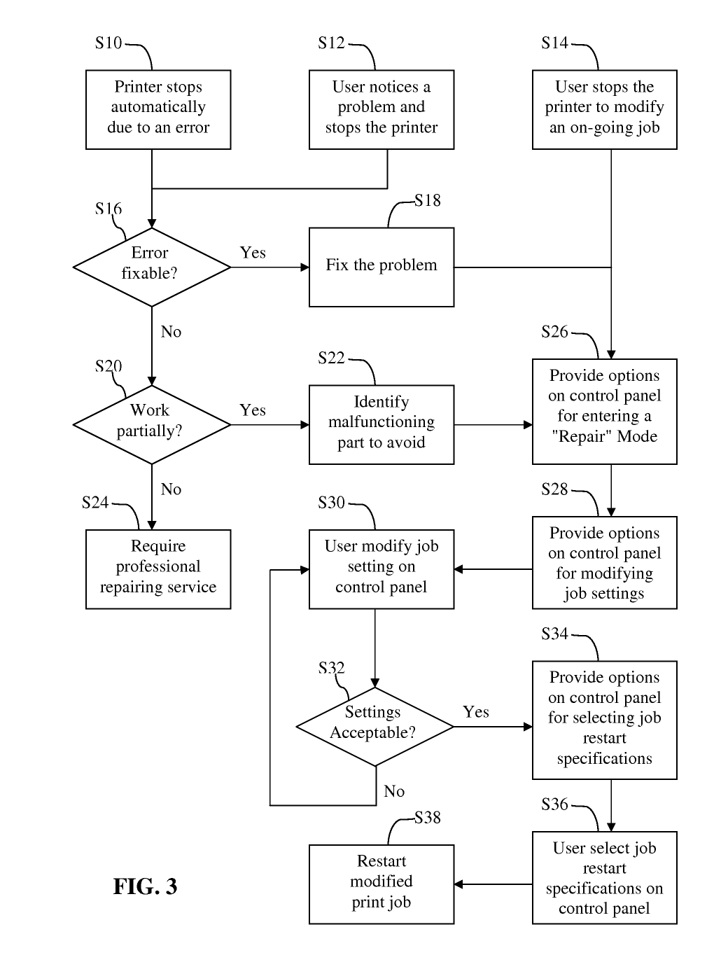

Referring to FIG. 3, a process implemented by a printer-based “on-the-fly” print job error recovery method and program according to an embodiment of the present invention is illustrated. In some cases the printer automatically stops an on-going printing job due to an error or problem (e.g., paper jam) of the printer (step S10). In other cases the user notices an error or problem (e.g. wrinkled paper or feed roller marring) and stops (pauses) the print job in order to correct the error or problem (step S12). If it is determined that the error or problem is fixable (step S16), the user can follow the on-screen prompt on the display of the control panel and fixes the printer as instructed (step S18). Here a “fixable” error or problem means a minor printer error or problem that can be fixed by a user on spot at the printer without requesting a professional repair service. Examples of typical fixable printer errors or problems may include paper jam, misfeed, wrinkled papers, empty paper tray, etc. Once the problem is resolved, in one example of the present invention, the program provides a graphical user interface (GUI) on the control panel display of the printer 102 with a prompt to ask the user if the user want to enter into a “Repair” mode (step S26)

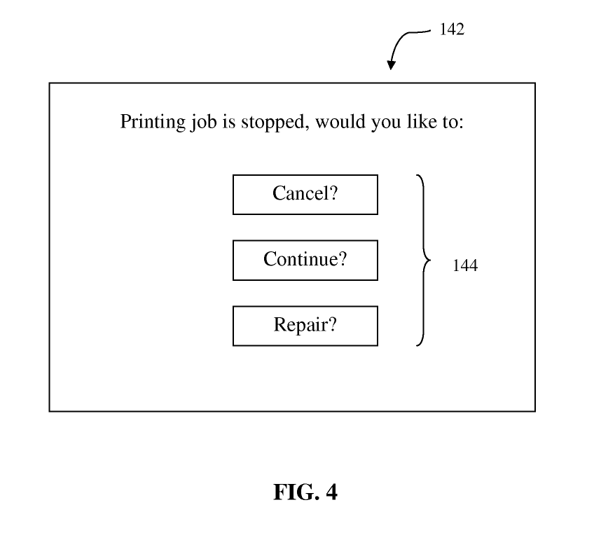

As shown in FIG. 4, on the display screen 142 of the printer control panel, a list of options 144 will be displayed. In addition to the conventional options of a “Cancel” mode that cancels the job and a “Continue” mode that continue to process the job, a new option of “Repair” mode is added by the present invention program.

The term “GUI” or “user interface display” is used herein to generally mean any suitable screen display that displays information to the user and/or allows the user to input commands and other information, and is not limited to any specific form of display, and may include a series of consecutive displays.

Referring again to FIG. 3, if the error or problem is not fixable, then it is determined whether the printer is still partially functional (step S20). For example, the double-sided paper path may be malfunction but the single sided paper path is still functional. Here a “non-fixable” printer error or problem means severe error or problem often resulting from structural, mechanical or electronic defects or malfunction of a printer part or unit that a user cannot readily fix on spot at the printer and professional repair service may be required. Minor errors or problems, such as paper jam, empty paper tray, etc., that can be readily fixed by a user on spot at the printer without requiring professional repair service are not considered herein as non-fixable errors or problems. Examples of a non-fixable printer error or problem may include a broken duplexing unit, a malfunctioning stapler unit, etc. If the printer is totally non-functional, or if the part that the user must use is malfunction, then professional repair service is required (step S24). Otherwise the malfunctioning part may be identified to avoid using it again (step S22), and the user can select the “Repair” mode in step 26 as described above.

Yet in some other cases a user may wish to modify an on-going print job. The user can stop the processing of job at the control panel of the printer (step S14). When this happens the exemplary program of the present invention again provides the GUI on the control panel display 142 of the printer, as shown in FIG. 4, where the user can enter into the “Repair” mode (step S26) in addition to the conventional “Cancel” and “Continue” options.

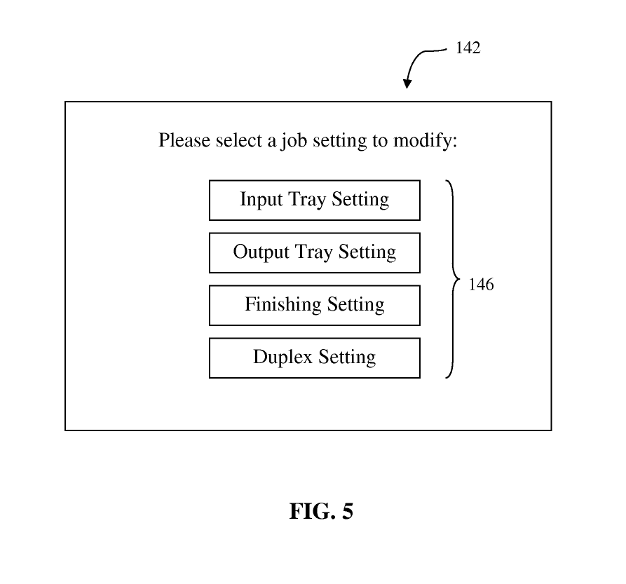

When the user selects the “Repair” mode, the exemplary program of the present invention provides a GUI on the control panel display 142 of the printer with job setting modification options, as shown in FIG. 5. The user can modify job settings directly at the control panel of the printer (step S30) without the need to go back to the user's computer and modify the job settings through a printer driver or other software program from the computer. If a printer part is malfunctioning, it can be disabled or avoided and the user will be provided with other options. For example, if the duplexing part is malfunctioning, then the user can choose to disable or avoid the duplex function and instead select other options for the print job to be done.

As shown in FIG. 5, the list 146 of available settings displayed at the GUI for the user to select may be only a sub-set of the full job settings, limited to those which rely on mechanical-specific settings (e.g. Input Trays, Output Trays, Finishing Options, Duplexing, etc.). The GUI may not list other settings that are not available because they cannot be modified once a job is rendered (e.g., resolution, etc.). The exemplary program of the present invention provides a way for the user to manually bypass mechanical issues/malfunctions by disabling the related settings or bypassing the offending parts and continue processing the same job, eliminating the need to split the job into two or more jobs.

Referring again to FIG. 3, the exemplary program of the present invention may include a step for verifying whether a setting selected by the user is acceptable to the printer or such choice is available at the printer (step S32). For example if the user choose to print in A4 paper, the program may verify whether the A4 paper tray is empty. Once the user's job setting modification or selections are verified to be acceptable or available, the printer will change the setting according to the user's selection and provide a GUI with job restart options or specifications for the user to select at the printer's control panel (step S34).

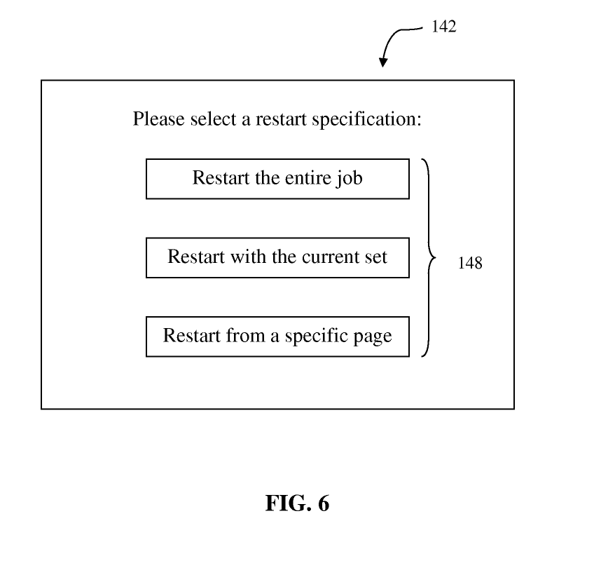

As shown in FIG. 6, the restart option GUI on the control panel display 142 allows the user to, for example, account for unprinted or unusable pages and adjust the job so that the print continues and generates the expected pages or sets of pages. The user may select from an restart option list 148 to choose to restart the entire job (in the case where a malfunctioning part/function such as duplexing is turned off), to restart with the current set that was being printed when the printer stopped (to recover the set), or restart from a specific page of the document being printed.

Referring to FIG. 3 again, once the restart values are selected by the user in step 36, the user releases the job and the job continues processing based on the modified settings the user has selected (step S38). Of course if a new error occurs, this same process may be applied again, as required, to correct the job.

The instant printer-based print job repair/recovery method and program reflecting some aspects of the present invention have many advantages. It provides an “on-the-fly” job repair mode to the printer, which allows a user to fix a problem that may or may not causes the printer to stop, or manually pause an on-going job even when the printer is working normally, to change a job setting at the printer's control panel. The “on-the-fly” job setting modifications is instantly applied to an on-going job after it restarts. The restart options and specification can quickly resolve copy/count problems, which helps control waste by allowing user to correct and reprocess same job (rather than splitting the job into multiple sets where user must manually track and recover from the waste, which increases the efficiency and reduces the confusion by keeping the entire process contained in a single job.

Although examples of the various steps of the present invention method and program are shown and described in detail here (e.g. FIG. 3), the present invention is not limited to the specifics of the flowchart described herein. The present invention may be implemented using any suitable forms of computer software programs.

It will be apparent to those skilled in the art that various modification and variations can be made to the methods and programs of the present invention without departing from the spirit or scope of the invention. Thus, it is intended that the present invention cover modifications and variations that come within the scope of the appended claims and their equivalents.

What is claimed is:

1. A method for recovering a printing job by a user from a printer's control panel after the printer is stopped and while the printing job is paused, the method comprising the steps of:
a. providing job setting options on the printer's control panel to allow a user to modify job settings of the printing job from the printer's control panel;
b. receiving a first user input on job setting modification;
c. providing job restart specifications on the printer's control panel to allow the user to select job restart specifications from the printer's control panel;
d. receiving a second user input on job restart specification; and
e. restarting the printing job based on the job setting modification and the job restart specification input by the user.

2. The method for recovering a printing job according to claim 1, further comprising the step of providing a user interface on the printer's control panel to allow the user to select an option that changes the printer into a repair mode.

3. The method for recovering a printing job according to claim 1, further comprising the step of verifying whether the modified job settings are compatible with the printer.

4. The method for recovering a printing job according to claim 1, wherein the printer is stopped automatically due to a printer error, the method further comprising the step of determining whether the error is a fixable error that can be readily fixed by the user on spot at the printer.

5. The method for recovering a printing job according to claim 4, wherein if the printer error is fixable, the method further comprising the step of fixing the printer error at the printer.

6. The method for recovering a printing job according to claim 4, wherein if the printer error is a non-fixable error that cannot be readily fixed by the user on spot at the printer, the method further comprising the step of determining whether the printer can still function partially.

7. The method for recovering a printing job according to claim 6, wherein if the printer can still function partially, the method further comprising the step of identifying a malfunction printer part that causes the non-fixable error so that it can be avoided in a restart printing job.

8. The method for recovering a printing job according to claim 7, further comprising the step of disabling the printer part that causes the non-fixable error.

9. A printer comprising:
a control unit which includes a memory for storing computer readable program code;
a control panel coupled to the control unit for providing a user interface;
a print engine controlled by the control unit; and
a processor for executing the code to control the printer, the computer readable program code being configured to cause the printer to execute a process for recovering a printing job by the user from the control panel after the printer is stopped and while the printing job is paused;
wherein the process comprises the steps of:
providing job setting options on the printer's control panel to allow a user to modify job settings of the printing job from the printer's control panel;
receiving a first user input on job setting modification;
providing job restart specifications on the printer's control panel to allow the user to select job restart specifications from the printer's control panel;
receiving a second user input on job restart specification; and
restarting the printing job based on the job setting modification and job restart specification input by the user.

10. The printer according to claim 9, wherein the user interface allows the user to select an option that changes the printer into a repair mode.

11. The printer according to claim 9, wherein the user interface on the printer's control panel provides a listing of printer mode options.

12. The printer according to claim 9, wherein the user interface on the printer's control panel provides a listing of printing job settings.

13. The printer according to claim 9, wherein the user interface on the printer's control panel provides a listing of job restart specifications.

14. The printer according to claim 9, wherein the printer is stopped automatically due to a printer error, and the process further comprises the step of determining whether the error is a fixable error that can be readily fixed by the user on spot at the printer.

15. The printer according to claim 14, wherein if the printer error is fixable, the process further comprises the step of fixing the printer error at the printer.

16. The printer according to claim 14, wherein if the printer error is a non-fixable error that cannot be readily fixed by the user on spot at the printer, the process further comprises the step of determining whether the printer can still function partially.

17. The printer according to claim 16, wherein if the printer can still function partially, the process further comprises the step of identifying a malfunction printer part that causes the non-fixable error so that it can be avoided in a restart printing job.

18. The printer according to claim 17, wherein the process further comprises the step of disabling the printer part that causes the non-fixable error.

19. The printer according to claim 9, wherein the process further comprises the step of verifying whether the modified job settings are compatible with the printer.

20. A method for recovering a printing job from a non-fixable problem of a printer part of a printer after the printer encounters the non-fixable problem during a printing process of the printing job, the method comprising the steps of:
a. receiving, from a user, a modification of a job setting that is originally set in the printing job, the modification of the job setting allowing the printer to execute the print job without using the printer part; and
b. resuming the print process of the printing job with using the modified job setting.

21. The method for recovering a printing job according to claim 20, further comprising the step of providing job setting options on the printer's control panel to allow the user to modify job settings of the printing job from the printer's control panel.

22. The method for recovering a printing job according to claim 20, further comprising the step of receiving a further user input to specify a job restart specification, such that the print process of the printing job is resumed with using the modified job setting and specified job restart specification.

23. The method for recovering a printing job according to claim 22, further comprising the step of providing job restart specifications on the printer's control panel to allow the user to select job restart specifications from the printer's control panel.

24. The method for recovering a printing job according to claim 20, further comprising the step of providing a user interface on the printer's control panel to allow the user to select an option that changes the printer into a repair mode.

25. The method for recovering a printing job according to claim 20, further comprising the step of verifying whether the modified job setting is compatible with the printer.

26. The method for recovering a printing job according to claim 20, wherein the printer is stopped automatically due to a printer error, the method further comprising the step of determining whether the error is a fixable error that can be readily fixed by the user on spot at the printer.

27. The method for recovering a printing job according to claim 26, wherein if the printer error is fixable, the method further comprising the step of fixing the printer error at the printer.

28. The method for recovering a printing job according to claim 26, wherein if the printer error is a non-fixable error that cannot be readily fixed by the user on spot at the printer, the method further comprising the step of determining whether the printer can still function partially.

29. The method for recovering a printing job according to claim 28, wherein if the printer can still function partially, the method further comprising the step of identifying a malfunction printer part that causes the non-fixable error so that it can be avoided in a restart printing job.

30. The method for recovering a printing job according to claim 28, further comprising the step of disabling the printer part that causes the non-fixable error.

31. A printer comprising:
a control unit which includes a memory for storing computer readable program code;
a control panel coupled to the control unit for providing a user interface;
a print engine controlled by the control unit; and
a processor for executing the code to control the printer, the computer readable program code being configured to cause the printer to execute a process for recovering a printing job by the user from the control panel after the printer is stopped and while the printing job is paused;
wherein the process comprises the steps of:
receiving, from the user, a modification of a job setting that is originally set in the printing job, the modification of the job setting allowing the printer to execute the print job without using the printer part; and
resuming the print process of the printing job with using the modified job setting.

32. The printer according to claim 31, wherein the process further comprises the steps of providing the job setting options on the printer's control panel to allow the user to modify job settings of the printing job from the printer's control panel.

33. The printer according to claim 31, wherein the process further comprises the step of receiving a further user input to specify a job restart specification, such that the print process of the printing job is resumed with using the modified job setting and specified job restart specification.

34. The printer according to claim 33, wherein the process further comprises the step of providing job restart specifications on the printer's control panel to allow the user to select job restart specifications from the printer's control panel.

35. The printer according to claim 31, wherein the process further comprises the step of verifying whether the modified job setting is compatible with the printer.

36. The printer according to claim 31, wherein the printer is stopped automatically due to a printer error, and the process further comprises the step of determining whether the error is a fixable error that can be readily fixed by the user on spot at the printer.

37. The printer according to claim 36, wherein if the printer error is fixable, the process further comprises the step of fixing the printer error at the printer.

38. The printer according to claim 36, wherein if the printer error is a non-fixable error that cannot be readily fixed by the user on spot at the printer, the process further comprises the step of determining whether the printer can still function partially.

39. The printer according to claim 38, wherein if the printer can still function partially, the process further comprises the step of identifying a malfunction printer part that causes the non-fixable error so that it can be avoided in a restart printing job.

40. The printer according to claim 38, wherein the process further comprises the step of disabling the printer part that causes the non-fixable error.
